(19) United States
(12) Patent Application Publication
(10) Pub. No.: US 2010/0017283 A1
(43) Pub. Date: Jan. 21, 2010

(54) DYNAMIC ADVERTISING SYSTEMS AND METHODS FOR VIRTUAL UNIVERSES

(75) Inventors: Rick A. HAMILTON, II, Charlottesville, VA (US); Brian M. O'connell, Cary, NC (US); Clifford A. Pickover, Yorktown Heights, NY (US); Keith R. Walker, Austin, TX (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 12/176,590

(22) Filed: Jul. 21, 2008

(51) Int. Cl. G06Q 30/00; G06T 15/00; G06F 17/30; G06F 7/06

(52) U.S. Cl. 705/14.25; 345/419; 707/104.1; 707/3; 707/E17.044; 707/E17.014

(57) ABSTRACT

A system and method implemented in a computer infrastructure having computer executable code, includes receiving bids for dynamic product placement advertisements in a virtual universe (VU) and performing a bid resolution for the received bids. Additionally, the system and method include rendering an object in the VU as a product placement advertisement by replacing a default texture of the object with a product placement texture based on the bid resolution.

### FIELD OF THE INVENTION

The present invention generally relates to computer-based virtual universes, and more specifically, to a method and system for providing dynamic product placement advertisements in a virtual universe.

### BACKGROUND OF THE INVENTION

Virtual universes (VUs) are rapidly becoming a popular part of today's culture. A VU is a computer-based simulated environment. Many VUs are represented using 3-D graphics and landscapes, and are populated by many thousands of users, known as “residents”. Often, the VU resembles the real world such as in terms of physics, houses, and landscapes.

VUs are also known as metaverses and “3D Internet.” Some example VUs include: SECOND LIFE™ENTROPIA UNIVERSE®, THE SIMS ONLINE™ and THERE™—as well as massively multiplayer online games such as EVERQUEST®, ULTIMA ONLINE™, LINEAGE® and WORLD OF WARCRAFT®. (SECOND LIFE is a trademark of Linden Research, Inc. in the United States and/or other countries. ENTROPIA UNIVERSE is a registered trademark of MindArk PE AB in the United States, other countries, or both. THE SIMS ONLINE and ULTIMA ONLINE are trademarks of Electronic Arts, Inc in the United States, other countries, or both. THERE is a trademark of Makena Technologies, Inc. in the United States, other countries, or both. EVERQUEST is a registered trademark of Sony Corporation of America, Inc. in the United States, other countries, or both. LINEAGE is a registered trademark of NCsoft Corporation in the United States, other countries, or both. WORLD OF WARCRAFT is a registered trademark of Blizzard Entertainment, Inc. in the United States, other countries, or both.)

A VU is intended for its residents to traverse, inhabit, and interact through the use of avatars. In operation, user(s) control the avatar(s). An avatar is a graphical representation of the user, often taking the form of a cartoon-like human or other figure. The user's account, upon which the user can build an avatar, is tied to the inventory of assets the user owns. A region is a virtual area of land within the VU, typically residing on a server. Assets, avatar(s), the environment, and everything else visually represented in the VU comprise universally unique identifiers (UUIDs) (tied to geometric data distributed to user(s) as textual coordinates), textures (distributed to user(s) as graphics files), and effects data (rendered by the user's client according to the user's preference(s) and user's device capabilities).

On-line virtual universes or environments present a tremendous new outlet for both structured and unstructured virtual collaboration, gaming and exploration, as well as real-life simulations in virtual spaces. These activities, along with yet to be disclosed new dimensions, in turn, provide a wide open arena for creative and new advertising methods and mechanisms. Immersive virtual universes, among other things, are an avenue to expose potential consumers to a company's advertising. One form of virtual universe advertising includes the display of billboards that are rendered on a user's (or client's) screen. With the astounding and continual increase in the number of users of virtual worlds, companies are taking more interest in reaching out to virtual world residents through advertising.

Product placement is an advertising tactic used by marketers in which a real commercial product is used in fictional or non-fictional media, and the presence of the product is a result of an economic exchange. Static product placement is placing a product within a virtual universe for purposes of advertising for a fixed cost, and all viewers of that scene see the same product. Current methods of static product placement in a virtual universe do not exploit the mechanisms within a virtual universe to deliver maximum profitability and flexibility to both advertisers and those involved in creation of a virtual universe scene.

### SUMMARY OF THE INVENTION

In a first aspect of the invention, a method implemented in a computer infrastructure having computer executable code, comprises a computer infrastructure having computer executable code, operable to receive one or more bids for one or more dynamic product placement advertisements in a virtual universe (VU) and perform a bid resolution for the one or more received bids. Additionally, the computer executable code is operable to render an object in the VU as a product placement advertisement by replacing a default texture of the object with a product placement texture based on the bid resolution.

In another aspect of the invention, a system comprises an object definition tool configured to modify an object's metadata, a bid placement tool configured to receive one or more bids for one or more dynamic product placement advertisements in a virtual universe (VU), and a placement resolution tool configured to determine an allocation of the one or more dynamic product placement advertisements based on the received bids. Additionally, the system comprises an invocation/placement tool configured to replace a default texture of the object with a product placement texture based on the allocation and a remuneration/billing tool configured to determine a cost to one or more advertisers and a remuneration for placing the one or more dynamic product placement advertisements.

In another aspect of the invention, a computer program product comprising a computer usable medium having readable program code embodied in the medium is provided. The computer program product includes at least one component operable to modify an object's metadata, receive one or more bids for one or more dynamic product placement advertisements in a virtual universe (VU) and determine an allocation of the one or more dynamic product placement advertisements based on the one or more received bids. Additionally, the at least one component is operable to replace a default texture of the object with a product placement texture based on the allocation.

In an additional aspect of the invention, a method comprises providing a computer infrastructure operable to receive one or more bids for one or more dynamic product placement advertisements in a virtual universe (VU) and perform a bid resolution for the received bids. Additionally, the computer infrastructure is operable to render an object in the VU as a product placement advertisement by replacing a default texture of the object with a product placement texture based on the bid resolution.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for implementing the steps in accordance with the invention;

FIG. 2 shows an exemplary bid submission form in accordance with the invention;

FIG. 3 shows an exemplary bidding table in accordance with the invention; and

FIG. 4 is an exemplary flow chart of steps for implementing aspects of the invention.

### DETAILED DESCRIPTION OF EMBODIMENTS OF THE INVENTION

The invention is directed to a method and system for advertising in a virtual universe, and more specifically, to a method and system for providing dynamic product placement advertisements in a virtual universe. The system is configured to provide (or a VU server may be augmented to provide) methods for dynamic (or just-in-time, real-time or on-the-fly) product placement advertisements. By implementing aspects of the invention, a default texture UUID for a generic object (e.g. such as a generic depiction of a generic product) may be dynamically replaced with an alternate texture UUID (e.g. for a specific product) based on a bidding system for placement of a product placement advertisement. Also, an advertiser may bid for dynamic product placement advertisements. Dynamic product placement has numerous advantages over static product placement including decreased cost per product placement for advertisers. Additionally, an object owner may increase their revenue by accepting product placement advertisements.

### System Environment

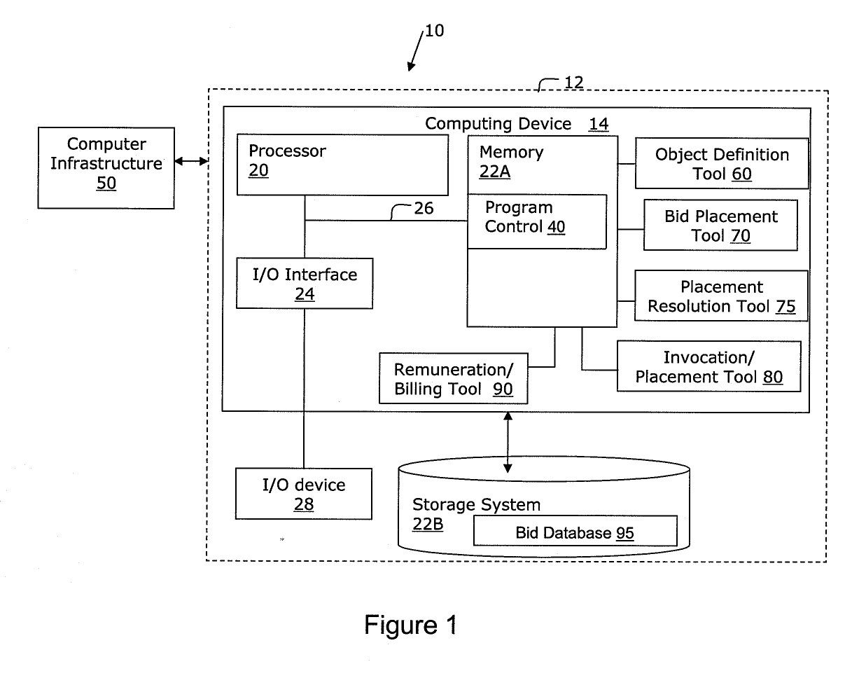

FIG. 1 shows an illustrative environment 10 for managing the processes in accordance with the invention. To this extent, the environment 10 includes a computer infrastructure 12 that can perform the processes described herein. The computer infrastructure 12 includes a computing device 14 that comprises an object definition tool 60, a bid placement tool 70, a placement resolution tool 75, an invocation/placement tool 80 and a remuneration/billing tool 90. These tools are operable to redefine objects for dynamic product placement, facilitate bid submissions, resolve the bidding process, invoke and perform the dynamic product placement and perform the remuneration/billing process for dynamic product placement advertisements in a VU, e.g., the processes described herein.

The computing device 14 includes a processor 20, a memory 22A, an input/output (I/O) interface 24, and a bus 26. The memory 22A can include local memory employed during actual execution of program code, bulk storage, and cache memories which provide temporary storage of at least some program code in order to reduce the number of times code must be retrieved from bulk storage during execution.

Further, the computing device 14 is in communication with an external I/O device/resource 28. The external I/O device/resource 28 may be keyboards, displays, pointing devices, etc. The I/O device 28 can interact with the computing device 14 or any device that enables the computing device 14 to communicate with one or more other computing devices using any type of communications link.

Additionally, in embodiments, the computing device 14 includes a storage system 22B. Storage system 22B may contain a bid database 95 for use by the computer infrastructure 12, as discussed further below.

The processor 20 executes computer program code (e.g., program control 40), which is stored in memory 22A and/or storage system 22B. While executing computer program code, the processor 20 can read and/or write data to/from memory 22A, storage system 22B, and/or I/O interface 24. The bus 26 provides a communications link between each of the components in the computing device 14.

The computing device 14 can comprise any general purpose computing article of manufacture capable of executing computer program code installed thereon (e.g., a personal computer, server, handheld device, etc.). However, it is understood that the computing device 14 is only representative of various possible equivalent computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the processes described herein. Further, while performing the processes described herein, one or more computing devices in the computer infrastructure 12 can communicate with one or more other computing devices external to computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols. For example, advertisers may submit bids to the computer infrastructure 12 via the communications link. Additionally, for example, object owners may modify object metadata via the communications link.

In embodiments, the computer infrastructure 12 may communicate with another computer infrastructure 50, which is operating the VU. However, the invention contemplates that the computer infrastructure 12 may operate the object definition tool 60, the bid placement tool 70, the placement resolution tool 75, the invocation/placement tool 80 and the remuneration/billing tool 90 (including the bid database 95) and operate the VU.

In embodiments, the invention provides a business method that performs the steps of the invention on a subscription, advertising, and/or fee basis. That is, a service provider, such as a Solution Integrator, could offer to perform the processes described herein. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

### Object Definition Tool

The object definition tool 60 is used to modify the object definition process (e.g., metadata of an object). The data representation of an object in a VU is stored as information, as either data or metadata. Metadata may be hidden textual data about characteristics of the object, which is not visible to a user of the object. In some virtual universes, larger objects are constructed of smaller objects, termed “prims” for primitive objects. These “prims” usually include boxes, prisms, spheres, cylinders, tori, tubes and rings. The “prims” may be rearranged, resized, rotated, twisted, tapered, dimpled and linked to create larger composite objects.

An object is created by an object creator, e.g., a VU manager, a VU owner, a user, etc. For example, a VU user may buy land in a VU and create objects on the land (e.g., a building, a sign, a billboard or a soda can). Additionally, for example, a VU owner may create objects dedicated for advertisements. The object creator may then map a texture or multiple textures to the object. Texture mapping is a method of adding detail, surface texture, or color to a computer-generated graphic or 3D model. When the object is to be rendered on a client's (or VU user's) computer, this information is transmitted from the VU server to the client. Entities, other than the object creator, may be allowed to alter the texture mapping of an object in the VU.

The object definition tool 60 is used (e.g., by an object owner) to modify the object definition process (e.g., metadata) for objects. The object metadata may be modified at any time (e.g., upon object creation or when an object is transferred from one owner to another owner). Modifying the object metadata can allow (or indicate permission for) the other entities to alter the texture mapping, such that those objects may be used for dynamic product placement in a VU. In embodiments, the object definition tool 60 may modify object metadata to include:

a flag, e.g., a Boolean flag, indicating if the object is to be used for dynamic product placement advertisements;

a texture associated with the object, which is the object's “default texture”;

keywords describing the object, for example, “Soda Can”, “Cola”, “Drink”; and/or

the account to receive remuneration when the object's default texture is replaced with a texture of a product placement advertisement.

More specifically, the object definition tool 60 may be used to modify the object definition, e.g., the object data or metadata, with a flag, e.g., a Boolean flag, indicating if the object is to be used, or is available, for dynamic product placement. Additionally, in embodiments, the object definition tool 60 may be used to place restrictions on the use of the object for product placement advertisements. That is, an owner of an object may not want to advertise under certain conditions or for certain advertisers.

In an example, the owner of a magazine object (e.g., a VU object in the form of a generic magazine) may not want their object to be used as a product placement advertisement for, e.g., a poster advertising a movie with mature content if younger VU users are present. Thus, for example, an object owner may indicate restrictions in the metadata, via the object definition tool 60. In embodiments, the restrictions can include restricting particular advertisers (e.g., no car advertisers), restricting particular advertisers under certain VU conditions (e.g., no advertisers of mature products if younger VU users in area), restricting the use of the object altogether under certain VU conditions (e.g., no product placement advertisements at night), restricting the use of the object in certain locations in the VU (e.g., no product placement advertisements in a place of worship or a government building) amongst other restrictions.

The object definition tool 60 may also be used to modify the object definition metadata to include a “default texture” associated with the object. In embodiments, the default texture may be represented as a Joint Photographic Experts Group (JPEG) file. In implementation, if an object is not used for a dynamic product placement advertisement, then the object will be rendered in the VU with its default texture.

The object definition tool 60 may also be used to modify the object definition metadata to include keywords describing the object. For example, if the object is a soda can, some keywords may include: “Soda Can”, “Cola”, “Drink”, etc. In embodiments, advertisers may use the keywords to identify objects in a VU that are suitable for dynamic product placement advertisements. For example, a soda company may be interested in placing product placement advertisements on soda cans, vending machines, and bottles. However, the soda company may not be interested in placing product placement advertisements on, for example, teddy bears, telephones, and coffee mugs. By associating VU objects with keywords, the object definition tool 60 allows a potential advertiser to identify those VU objects that may be most suitable for the advertiser's products.

An object in a VU may already be described with undedicated “descriptor” and/or “category” fields. In embodiments, these undedicated fields (e.g., not dedicated to the dynamic product placement system) may additionally or alternatively be used to facilitate the matching of objects and advertisers.

The object definition tool 60 may also be used to modify the object definition metadata to include account identification information for the account to receive remuneration when the object's texture is replaced with that of a product placement. That is, in order to allow the dynamic product placement system to direct compensation from an advertiser to an object owner, the object definition tool 60 may also be used to modify the object definition metadata to include account identification information of, e.g., the object owner.

In VUs, objects may be created by, for example, VU owners, VU operators, and users (or residents), amongst others. Additionally, in VUs, whoever creates an object is usually deemed to own that object. However, an object creator may, for example, give, trade or sell an object to another user in the VU, such that the other user is the new owner of the object.

In embodiments, the account to receive remuneration for the dynamic product placement may be the account of the object's owner. That is, if an object's default texture is replaced with a texture of a product placement advertisement, the object's owner may be compensated for the product placement. In a further embodiment, an object's owner may assign compensation to another user by modifying the object metadata, via the object definition tool 60, accordingly. Additionally, if the object was created by an object creator and then, e.g., given to another user in the VU, the object metadata may be updated, via the object definition tool 60, to reflect the current owner of the object. However, the invention contemplates that, in embodiments, an object creator may still receive payment for objects they no longer own.

Thus, as explained further below, if an object is selected by an advertiser for dynamic product placement advertising, the modification of the object definition metadata to include account identification information, via the object definition tool 60, allows the dynamic product placement system to determine which account will receive remuneration.

### Bid Placement Tool

The bid placement tool 70 may be used to facilitate the placing of bids for dynamic product placement advertisements in a VU. Unlike traditional product placement in which two parties negotiate and exchange goods or services for product placement, dynamic product placement allows advertisers to bid for product placement advertisements.

Allowing advertisers to perform bidding, via the bid placement tool 70, enables increased revenue for those accepting product placement bids (e.g., object owners, VU operators, or service providers) because multiple people can bid and have theirs bids accepted for product placement. Bidding also enables a wider range of companies to perform product placement for several reasons, including:

a relationship does not need to be established between the advertiser and object creators and/or object owners for product placement advertisements; and

companies can bid what they can afford and still obtain exposure, while other companies can bid more for greater exposure.

In embodiments, bidding may be conducted according to a regular schedule, e.g., daily, weekly, monthly, etc., or may be conducted dynamically in real-time, wherein bids may be submitted on an ongoing basis. Moreover, the bids may last for a fixed period of time, e.g., daily, weekly, monthly, etc., such that at the end of the fixed period, an advertiser would need to re-bid in order to place a dynamic product placement advertisement. Additionally, the invention may incorporate service level agreements that prevent an accepted bid from being rescinded. That is, the advertisers and, e.g., the VU owner, VU operator or service provider, may agree that once a bid is accepted, that bid cannot be rescinded.

The bidding for generic UUID texture replacement (e.g., product placement) may commence at various times. For example, a presenter of a play may, in advance, open the bidding for replacement. The bidding may also take place during the time the product is being displayed. This may be useful when new viewers “tune in” to the play during its presentation. Bids may be accepted by participating parties who are within the VU. Alternatively, bids may be acquired outside of the VU, for example, at a web site.

In embodiments, an advertiser may have pre-arranged agreements with, e.g., a VU manager, a service provider or client, that provide for a right of first refusal or right of bid matching. That is, for example, a preferred advertiser may have agreements that allow the advertiser, for example, to match another advertiser's higher bid for placing a dynamic product placement advertisement. Thus, in a dynamic real-time bidding system, if another advertiser submits a new bid higher than a preferred advertiser's existing highest-ranked bid, the preferred advertiser may be given the opportunity to, e.g., match or overbid the newly received bid.

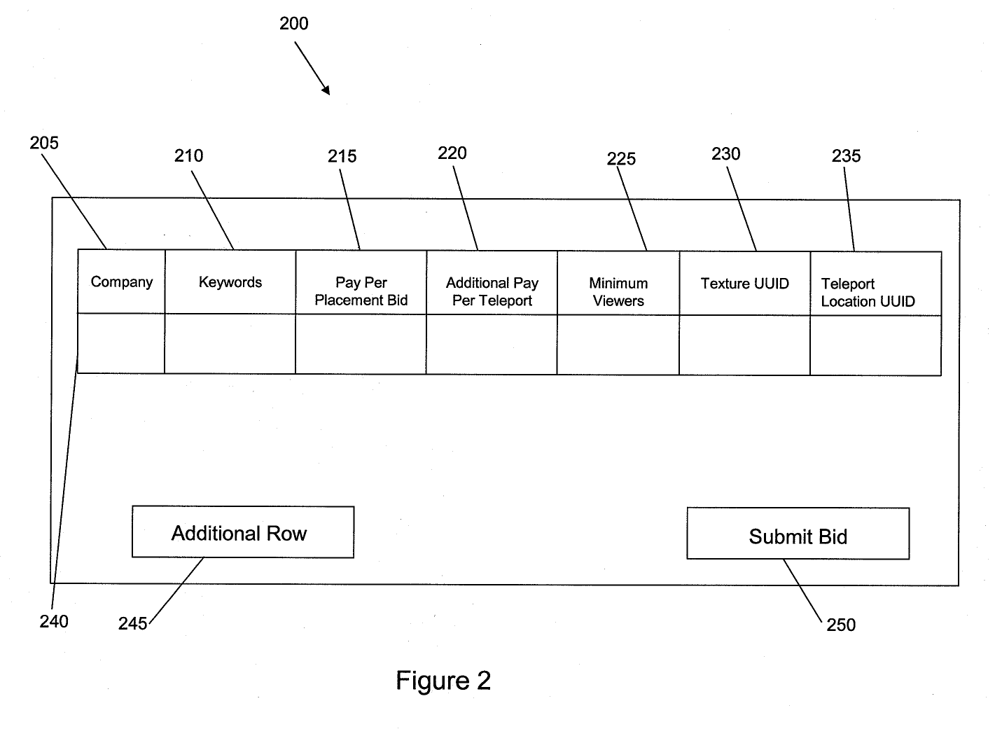

FIG. 2 shows an exemplary bid submission form 200 of the bid placement tool 70. It should be understood that FIG. 2 is one of many potential architectural models for the submission of bids to the bid placement tool 70, and should not limit the scope of the present invention.

The bidding process is embodiment dependent and may occur within or outside of a VU. Accordingly, if the bidding process occurs within a VU, the bid submission form 200 may be displayed to a user, e.g., an advertiser, within the VU. If the bidding process occurs outside of a VU, the bid submission form 200 may be displayed to an advertiser, for example, through a website portal. It should be understood, however, that the invention contemplates manual submissions of bids, as well. That is, an advertiser may submit a bid, e.g., to a VU owner, a VU operator or a service provider via conventional mail or other conventional methods.

As shown in FIG. 2, a company (e.g., ABC, DEF, etc.) wishing to bid on a dynamic product placement advertisement may supply relevant data in a row 240 of the exemplary bid submission form 200. FIG. 2 has fields for “Company” 205, “Keywords” 210, “Pay Per Placement Bid” 215, “Additional Pay Per Teleport” 220, “Minimum Viewers” 225, “Texture UUID” 230, and “Teleport Location UUID” 235. More specifically, the “Company” field 205 may be used to indicate the company (or entity) placing the bid for product placement. The “Keywords” field 210 may be used to indicate keyword(s) for a particular bid. The keywords information in this field may be used to match against the keywords of the objects in the metadata provided via the object definition tool 60, as described above.

The “Pay Per Placement Bid” field 215 may be used to indicate the amount of the placed bid. More specifically, the “Pay Per Placement Bid” field 215 may be used to indicate how much the company is willing to remunerate for every instance of this product placement advertisement.

The “Additional Pay Per Teleport” field 220 may be used to indicate how much in addition to the per placement payment the company will remunerate if a user initiates a teleport command, e.g., selects the object and requests to teleport to a designated location (e.g., an advertisement space), to find out more information about the product. For example, an advertiser, e.g., company ABC, may have a product placement advertisement for soda on a soda can object. A participant in the VU may see the soda can with the product placement advertisement and, for example, decide that they want more information about that product. In embodiments, the participant may initiate a teleport control, e.g., “click” on the soda can, and be teleported, e.g., to company ABC's website. The teleportation of the participant to company ABC's website provides further advertising benefits, e.g., exposure, to company ABC. Thus, the “Additional Pay Per Teleport” field 220 may be used to indicate an amount a company is willing to pay to an object owner for each instance of a participant teleportation, with, e.g., limits, such as, to prevent a participant from generating inflated remuneration through repeat teleportation.

The “Minimum Viewers” field 225 may be used to indicate a required number of avatars (or participants in the VU) that are in the region or area of the VU where the object is present. That is, an advertiser may only wish to place a product placement advertisement on an object in the VU if there are sufficient numbers of current viewers (participant avatars), or potential viewers in the region or area of the object. In a VU, a region refers to a specific piece of virtual real-estate. In embodiments, the “Minimum Viewers” field 225 may be used to indicate a required number of avatars viewing the object simultaneously before a company is willing to pay for product placement. In an additional embodiment, the “Minimum Viewers” field 225 may be used to indicate a required number of avatars in the region or area of the VU where an object is located before a company is willing to pay for product placement. Thus, the advertiser, using the bid submission form 200 generated by the bid placement tool 70, may indicate a minimum number of viewers that must be present in order to invoke their bid and place the product placement advertisement.

Moreover, the invention contemplates that, in embodiments, a bid submission form 200 may include fields for both a minimum number of actual viewers and a minimum number of potential viewers, and fields for per placement bids for each situation. With this embodiment, for example, an advertiser may bid to pay a price for a minimum number of potential viewers, and may bid to pay another price (e.g., a higher price) for a minimum number of actual simultaneous viewers.

In additional embodiments, the bid submission form may include a field for a minimum time of a view. In such an embodiment, an advertiser may restrict their bid such that it is only invoked after, e.g., a minimum number of viewers have viewed the object (or remained in the area) for a minimum amount of time, e.g., 30 seconds.

The “Texture UUID” field 230 may be used to indicate a universally unique identifier (UUID) of a texture to map over the object. A UUID is an identifier standard used in software construction. The intent of UUIDs is to enable distributed systems to uniquely identify information without significant central coordination. Thus, anyone can create a UUID and use it to identify something with reasonable confidence that the identifier will never be unintentionally used by anyone for anything else. Information labeled with UUIDs can therefore be later combined into a single database without needing to resolve name conflicts.

Thus, the “Texture UUID” field 230 may be used to indicate a universally unique identifier (UUID) of a texture to map over the object. This texture mapping is the virtual product placement advertisement. That is, the texture UUID identifies the texture that will replace an object's default texture. In embodiments, the texture may be a JPEG file. In embodiments, the indication of the UUID may be transparent to the advertiser. That is, the advertiser may use an interface to select a texture without seeing the UUID mapped to the texture or generated for the texture.

The “Teleport Location UUID” field 235 may be used to indicate a UUID of a location to which a customer may be teleported, if the customer requests a teleport to, e.g., learn more about a product. That is, as described above, a customer may, e.g., “click” on an object or otherwise indicate a desire to be teleported. Thus, an advertiser may indicate the UUID of that teleportation location in order to facilitate teleportation. In embodiments, the indication of the UUID may be transparent to the advertiser. That is, the advertiser may use an interface to select a set of positional coordinates or area without seeing the UUID mapped to the location or generated for the location.

The invention contemplates that a same company may place bids for multiple keywords for multiple advertisements (either within a same region or area of a VU, or in another region or area of a VU) during a single submission of the bid submission form 200. Thus, a user may create additional rows in the bid submission form 200 as needed to enter additional bids, for example, by “clicking” an “Additional Row” button 245.

In embodiments, the bid placement tool 70 may be configured to allow a bidder to restrict their bids to specific times, locations, or object owners within the VU. That is, for example, an advertiser may only be interested in advertising during specific hours. Additional embodiments may restrict bids to objects that are under control of specific avatars. For example, an advertiser may not want their products associated with avatars having particular qualities or attributes (e.g., avatars having vulgar outfits, younger users). Thus, in embodiments, the bid submission form may include one or more fields (not shown) for inputting restrictions (e.g., temporal, contextual, location) on the advertising. The placement resolution tool 75 and/or the invocation/placement tool 80 may use these inputted restrictions as described further below.

In further embodiments, in order to place location restrictions on their advertisements, an advertiser may use, for example, a two-dimensional image of a VU to selectively block out areas of the VU, in which the advertiser does not wish to place their product placement advertisements. Additionally, an advertiser may move through a VU and click areas in which they do not wish to place their product placement advertisements. These locations may be given location UUIDs for identification by the invention. This information may be placed in a relational database, e.g., storage system 22B, relating the advertiser with the restricted area/location UUIDs. For example, a table of restrictions for an advertiser may be compiled for each bid received by that advertiser. Additionally, an advertiser may have global restrictions for all their product placement advertisements, such that a table of global restrictions for that advertiser may be compiled.

Upon completing the bid submission form 200, an advertiser may submit the bid submission form by, for example, “clicking” the “Submit Bid” button 250. Upon receiving the bid, the bid placement tool 70 may place the submitted bid information into a “bidding” data store, e.g., a bid database 95.

### Placement Resolution Tool

The placement resolution tool 75 uses the object metadata and information in the “bidding” data store, e.g., the bid database 95, to determine which objects to be used for dynamic product placement advertisements in a VU. Additionally, the placement resolution tool 75 may examine the surrounding environment of an object to determine if parameters have been met for placing a dynamic product placement advertisement.

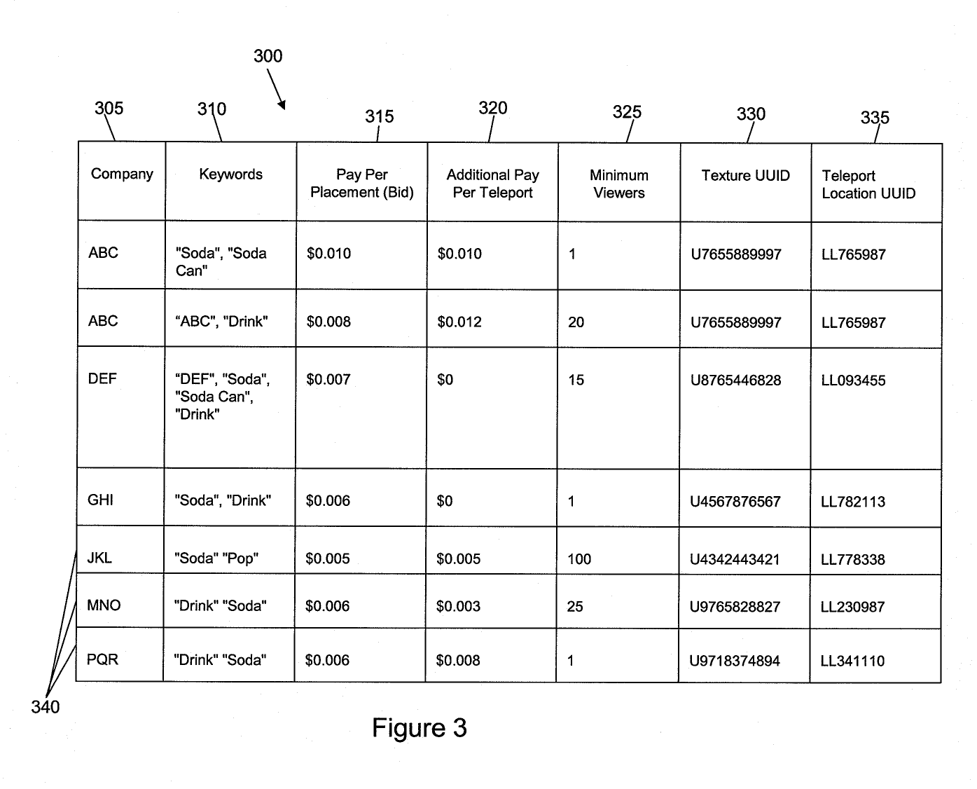

FIG. 3 shows an exemplary table of bids 300 for keywords, received from a plurality of advertisers, through the bid placement tool 70. It should be understood that FIG. 3 is one of many potential architectural models for table of bids 300, and should not limit the scope of the present invention. It should also be noted that this is a simplified example and real implementations may have several hundreds of bids.

As shown in FIG. 3, companies (e.g., ABC, DEF, etc.) have bid for product placements by supplying relevant data, as shown in rows 340 of the exemplary bid table 300. The bid table 300 may have columns for “Company” 305, “Keywords” 310, “Pay Per Placement Bid” 315, “Additional Pay Per Teleport” 320, “Minimum Viewers” 325, “Texture UUID” 330, and “Teleport Location UUID” 335. Additionally, the bid table 300 has a row 340 for each keyword (or set of keywords) that has received a bid for a product placement advertisement, indicating the company, the pay per placement bid, the additional pay per teleport, a minimum number of viewers, a texture UUID and a teleport location UUID for that keyword (or set of keywords). Furthermore, in embodiments, the bidding table may include, e.g., additional columns for other bid restrictions, for example, if those restrictions were solicited and/or submitted, e.g., in the bid submission form 200. It should be understood to one of ordinary skill in the art that UUIDs may be represented, for example, in a hexadecimal form or as a concatenation of a character (e.g., “U” or “LL”) with a UUID, as shown in FIG. 3.

As additionally shown in FIG. 3, an advertiser may choose not to bid for an additional payment for teleport. For example, company DEF and Company GHI did not submit bids for an additional payment for teleport (even though both companies submitted their bids with teleport location UUIDs). As shown in FIG. 3, the additional pay per teleport amount may be unrelated to the pay per placement bid amount. For example, some advertisers may pay more than their bid amount for the teleport, while others may pay less or the same amount. Furthermore, the invention contemplates that, in embodiments, the additional payment for teleport information need not be collected in the bid placement process.

In embodiments, the bid table 300 may remain hidden to bidding advertisers. That is, the bid table 300 may be compiled from the data contained in the bid database 95 and used internally by the placement resolution tool 75 without being disclosed externally. However, the invention also contemplates an open bidding process, in which bidders may view other received bids. With this embodiment, the complete bid table 300 may be presented to bidding advertisers. Additionally with this embodiment, in order to preserve the identity of the other advertisers, the company data may be withheld or encrypted. Alternatively, the dynamic product placement system may only display a unique company identification that is known to the dynamic product placement system, but unknown to other advertisers.

In implementation, the placement resolution tool 75 may perform an analysis of objects in a VU and the received bids to determine which objects may be used for product placement advertisements. In an exemplary embodiment, the placement resolution tool 75 may query the metadata of objects in the VU. For each keyword listed in an object's metadata, the placement resolution tool 75 may retrieve all bids from the bidding data store, e.g., the bid database 95, that have matching keywords. That is, the placement resolution tool 75 may perform a matching comparison between each keyword listed in an object's metadata, as modified by the object definition tool 60, and the keywords (as shown in the “Keywords” column 310) submitted by advertisers using the bid placement tool 70.

Additionally, in embodiments, the placement resolution tool 75 may determine if the VU parameters meet any bid restrictions. For example, an advertiser may restrict their bid, such that it is only invoked if a minimum number of viewers are present (e.g., a number of avatars simultaneously viewing the object, or a number of avatars in the region or area of the object, as explained above). Additionally, an advertiser may restrict their bid, such that it is only invoked if, for example, the area in the VU is not dark (e.g., at nighttime within the VU). Accordingly, the placement resolution tool 75 may examine the surrounding environment of the VU and determine, e.g., if a minimum number of viewers are present or if a minimum number of lumens (unit of luminous flux, a measure of the perceived power of light) are present in the VU. In embodiments, the placement resolution tool 75 may determine the number of avatars simultaneously viewing the object or a number of avatars in the region or area of the object by setting a crowdedness indicator measured by the number of avatars per a defined size of area.

If the placement resolution tool 75 determines that VU parameters do not meet the bid restrictions (e.g., the number of avatars is below minimum viewers threshold for a bid, or the VU is too dark), the placement resolution tool 75 may remove that bid from consideration for product placement advertisement. However, the invention contemplates that parameters may change in a VU relatively quickly. Thus, in embodiments, the placement resolution tool 75 may analyze parameters in the VU in real-time, and re-insert bids that were removed from consideration, if conditions in the VU permit (e.g., the restriction of the bid has been met).

As described above, there may be some objects within a VU that are not available for dynamic product placement. That is, an advertiser may not be allowed to alter the texture mapping of some objects in the VU. The object's data or metadata may indicate if an object is not available for dynamic product placement. Thus, the object definition tool 60 will not modify the object definition of these objects. Additionally, if an advertiser places a bid on keywords for a dynamic product placement advertisement, via the bid placement tool 70, and the placement resolution tool 75 identifies a match to an object that is not available for dynamic product placement, the placement resolution tool 75 may not include the placed bid in the bid resolution process, as described further below. Furthermore, if an advertiser places a bid on keywords for dynamic product placement and the placement resolution tool 75 identifies a match to an object whose restrictions preclude its use for a dynamic product placement advertisement under particular conditions (e.g., a particular advertiser, or particular VU conditions), then the placement resolution tool 75 may not include the placed bid in the bid resolution process.

For the remaining bids (that have not been removed from the bidding resolution process due to restrictions), the placement resolution tool 75 may allocate product placement advertisements to viewers in the VU. Moreover, the placement resolution tool 75 may allocate different product placement advertisements to different viewers. That is, for a particular object that has a matching keyword with a plurality of advertisers, the placement resolution tool 75 tool may dynamically allocate the product placement advertisements, such that different viewers of that object in a VU may be presented with different product placement advertisements on their respective computers.

In embodiments, for those companies that bid more per placement, the placement resolution tool 75 may allocate their product placement advertisements to be placed for more viewers. The percentage of product placements for viewers may be proportional to the pay per placement bid.

For example, using the bidding data as shown in the exemplary bid table 300 of FIG. 3, and assuming that the placement resolution tool 75 has determined that there are two hundred avatars looking at a region of a VU that has an object for product placement, the placement resolution tool 75 may determine an allocation of product placement advertisements for that object. With this example, the metadata for the object, as modified by the object definition tool 60, has a keyword of “soda.”

The placement resolution tool 75 may determine from the information contained in the bidding table 300, that six of the seven entries have indicated “soda” as a keyword. Thus, those six entries may be considered for product placement advertisements and the one without “soda” as a keyword is not considered for product placement advertisements.

Additionally, the placement resolution tool 75 may determine, depending on embodiments, a number of avatars that are in the region of the object or a number of avatars simultaneously viewing the object. Furthermore, the placement resolution tool 75 may compare the determined number of avatars with the data indicating the minimum number of viewers required, as supplied by the advertisers in the bid submission form 200. As explained above, if the placement resolution tool 75 determines that there are fewer avatars in the region of the object than the minimum required by an advertiser, then the placement resolution tool 75 may remove that bid from consideration. With this example, since the placement resolution tool 75 has determined that there are two hundred avatars looking at the region and that two hundred viewers is more than the minimum required for each of remaining bids, the placement resolution tool 75 determines that each of the remaining bids is valid.

The placement resolution tool 75 may compare the remaining bids to allocate the product placement advertisements amongst the viewers. In embodiments, the percentage of product placements for viewers may be proportional to the pay per placement bid. With the above example, as shown in FIG. 3, there is one bid of $0.005, three bids for $0.006, one bid for $0.007 and one bid for $0.010 for the keyword “soda”. The placement resolution tool 75 may determine a total amount of all bids. For example: $0.005+$0.006+$0.006+$0.006+$0.007+$0.010=$0.04. Additionally, the placement resolution tool 75 may determine for each individual bid a percentage of the total amount of all bids. For example: $0.005/$0.04=12.5%, $0.006/$0.04=15%, $0.007/$0.04=17.5%, $0.010/$0.04=25%.

The placement resolution tool 75 may then determine percentages for each product placement. Thus, with the above example and with the understanding that with this example the object is a soda can, the placement resolution tool 75 determines that 25% of the viewers will see an ABC can, 17.5% will see a DEF can, 15% will see GHI can, 15% will see MNO can, 15% will see PQR can and 12.5% will see a JKL can.

It should be understood that the invention contemplates other bidding resolution methods, and the invention should not be limited to the above embodiment. For example, other potential bidding resolution methods include, but are not limited to: high bid seen by all viewers, round robin selection for same priced bids, open bidding, closed bidding, etc.

As a further example, the bid placement tool 70 may be configured to allow mixed bids. For example, an advertiser may place a mixed bid of $10 if there are 100 viewers, or $0.01 per viewer. Additionally, a second advertiser may bid $0.05 per viewer. Assuming a situation where there are 105 current viewers, using the higher per viewer bid would result in remuneration of 105×$0.05=$5.25. However, in embodiments, the placement resolution tool 75 may be configured to maximize an object owner's remuneration for accepting product placement advertisements. Thus, the placement resolution tool 75 may determine a maximum remuneration of $10 (for 100 viewers)+5 viewers×$0.05=$10.25. As $10.25 is more than $5.25, the placement resolution tool 75 may allocate the product placement advertisements according to this alternative bid resolution methodology.

In additional embodiments, an operator or user of the dynamic product placement system (e.g., a VU operator, VU owner, or service provider) may set limits on a number of bids. Moreover, an operator may delete or forbid bids from particular advertisers. In embodiments, an operator may delete or forbid bids, for example, in order to control a number of entries in the bidding table 300 or for preventing competition lockout when a malicious bidder consumes an imposed limit by placing numerous low bids.

If an object is created and no matching bids exist for the object's keywords, then the default texture for the object, as defined via the object definition tool 60, may be used.

### Invocation/Placement Tool

The invocation/placement tool 80 may be used to invoke the dynamic product placement system and place product placement advertisements in the VU based upon the determinations of the placement resolution tool 75. In embodiments, the invocation/placement tool 80 may invoke the dynamic product placement system when the invocation/placement tool 80 detects an object (or objects) containing metadata indicating product placement compatibility within a region of a VU and viewable by avatars.

Additionally, after invocation, the invocation/placement tool 80 may use the information derived by the placement resolution tool 75 to disperse product placement advertisements to viewing avatars according to the percentages determined by the placement resolution tool 75. More specifically, the invocation/placement tool 80 replaces the default texture UUID for the object with the texture UUID, as determined by the placement resolution tool 75, for every avatar viewing the region.

Continuing with the above example, assuming that the object data containing the geometric information of a “soda can” is stored with a UUID of O98742213, the invocation/placement tool 80 transmits the geometric region information and texture information for rendering the region on a VU client's (or user's) computer. However, the invocation/placement tool 80 will transmit different texture UUIDs (associated with the different product placement textures for the object) to different VU clients (or users) according to the proportions determined by the placement resolution tool 75. For example 25% of the VU clients will receive a texture UUID of U7655889997 (ABC can) associated with the object, 17.5% will see a texture UUID of U8765446828 (DEF can) associated with the object, etc. VU clients may retrieve the associated details for the texture including rendering information by using the texture UUID. The details associated with that key may be retrieved from a VU server or a server dedicated to providing details about textures. Moreover, the VU server or the dedicated server may be backed-up by a database.

### Remuneration/Billing Tool

The remuneration/billing tool 90 may be used to determine the amount to charge each advertiser for product placement advertisement and the amount to remit to an object owner's account for the product placement advertisement. More specifically, based on the information derived from the placement resolution tool 75 and/or the invocation/placement tool 80, the remuneration/billing tool 90 can determine how many instances of product placement advertisements occurred for a particular advertiser. Thus, based on the pay per placement bid, the remuneration/billing tool 90 can determine the amount to charge each advertiser. Moreover, in embodiments, the remuneration/billing tool 90 may be configured to collect payment from the advertisers.

Additionally, based on the information derived from the invocation/placement tool 80, the remuneration/billing tool 90 can determine which objects were used to place the product placement advertisements. Moreover, using the information collected by the object definition tool 60, the remuneration/billing tool 90 can identify the account to receive remuneration when the object's default texture is replaced with that of a product placement texture. Moreover, in embodiments, the remuneration/billing tool 90 can remit payment to those identified accounts.

Known methods may be used for electronic billing of advertisers as well as known methods for transferring funds to object owners. Additionally, in embodiments, revenue may be generated by the VU (or those running this service for the VU) by collecting a percentage of the money transferred as a fee. In this case, the VU can be considered the service provider. In embodiments, billing information may be associated with the company prior to bid submission. As described above, remittance information for object owners may be placed inside the metadata of the object.

### Additional Embodiments

Numerous modifications are possible without deviating from the scope of this invention. For example, some embodiments may offer more targeted product placement by analyzing the contents of the viewing avatar's inventory. For example, the placement resolution tool 75 may be configured to additionally examine an object owner's assets and/or inventory. For example, if an object owner has a lot of assets (e.g., a DEF company hat, a DEF company shirt and a DEF company coffee mug) associated with a particular advertiser (e.g., DEF company), that advertiser may not want to pay the object owner for a product placement advertisement. An advertiser in this situation may view an expenditure for a product placement advertisement for such an object owner as a waste of money, as the object owner is likely to be advertising the company already.

In embodiments, VU owners or VU managers may take a percentage of generated advertisement revenue. Thus, the invention contemplates that a percentage of the remuneration due to the object owners may be diverted to, e.g., the VU owner. With these embodiments, the remuneration/billing tool 90 may be configured to account for a percentage cut to be paid to, e.g., the VU owner, or a service provider. In embodiments, the percentage cut may be paid from the advertisers directly or may be paid or diverted from the object owners.

In further embodiments, the bid placement tool 70 and the placement resolution tool 75 may be configured, such that an advertiser may include in the bid a premium to be remunerated to an object owner, if the object owner allows the product placement advertisement to remain static. That is, even though a higher bid may be subsequently received for a product placement advertisement, the placement resolution tool may be configured to maintain the current product placement advertisement even though a higher bid has been placed. The product placement advertisement may be static, for example, for a period of time or for a certain number of viewers. By implementing this aspect of the invention, an advertiser may reward an object owner for loyalty.

Additionally, while the invention has been described using the object definition tool 60, the bid placement tool 70, the placement resolution tool 75, the invocation/placement tool 80 and the remuneration/billing tool 90 to control the dynamic product placement system, the invention contemplates that operations performed by these tools may be performed manually by, e.g., a VU manager, an advertiser or a service provider.

### Flow Diagram

The steps of the flow diagram described herein may be implemented in the environment of FIG. 1. The flow diagram may equally represent a high-level block diagram of the invention. The steps of the flow diagram may be implemented and executed from either a server, in a client server relationship, or they may run on a user workstation with operative information conveyed to the user workstation. Additionally, the invention can take the form of an entirely hardware embodiment, an entirely software embodiment or an embodiment containing both hardware and software elements. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

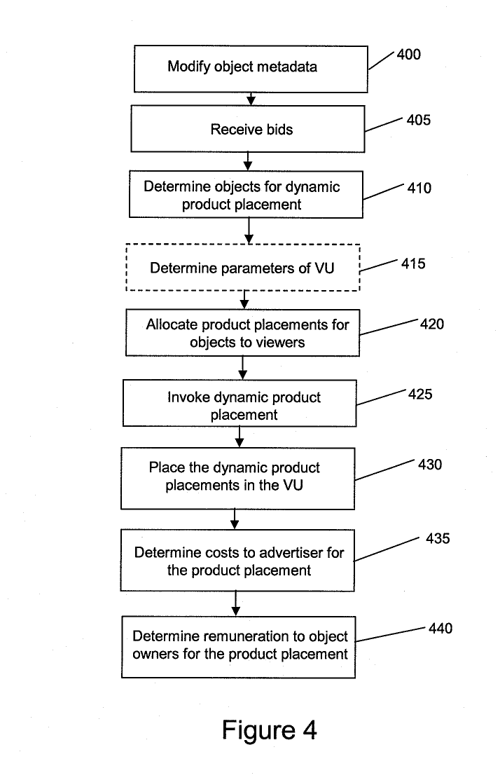

FIG. 4 shows an exemplary flow diagram for performing steps of the invention. At step 400, object metadata is modified via the object definition tool. In embodiments, object metadata may be modified, e.g., by the object owner. At step 405, bids are received via the bid placement tool. At step 410, the placement resolution tool determines objects that are suitable for product placement. At optional step 415 (indicated by hidden lines), the placement resolution tool determines parameters of the VU. For example, the placement resolution tool may determine the number of avatars in a region of a VU near an object. Additionally or alternatively, the placement resolution tool may determine the number of avatars looking at an object. Furthermore, the placement resolution tool may determine if any conditions of the VU trigger restrictions (e.g., object owner restrictions and/or advertiser restrictions). At step 420, the placement resolution tool allocates the product placement advertisements to the viewers (avatars).

At step 425, dynamic product placement is invoked. In embodiments, the invocation/placement tool may locate a product suitable for product placement advertisements and invoke the dynamic product placement system. At step 430, the invocation/placement tool may place the dynamic product placement advertisement in the VU according to the determinations of the placement resolution tool. At step 435, the remuneration/billing tool determines the costs to advertisers for the product placements and bills the advertisers for the product placements. At step 440, the remuneration/billing tool determines the remuneration to object owners for the product placements and remunerates payment to the object owners for the product placements.

It should be understood, that while the steps have been described as occurring in a particular order, the invention contemplates that the steps may be performed in other orders. For example, step 410 may occur after step 415. Furthermore, the invention contemplates that, in embodiments, steps may be implied or omitted while still remaining within the scope of this invention.

While the invention has been described in terms of embodiments, those skilled in the art will recognize that the invention can be practiced with modifications and in the spirit and scope of the appended claims.

What is claimed is:

1. A method implemented in a computer infrastructure having computer executable code, comprising:
receiving one or more bids for one or more dynamic product placement advertisements in a virtual universe (VU);
performing a bid resolution for the one or more received bids; and
rendering an object in the VU as a product placement advertisement by replacing a default texture of the object with a product placement texture based on the bid resolution.

2. The method of claim 1, further comprising modifying metadata of the object to include at least one of:
an indication that the object is available for the one or more dynamic product placement advertisements;
a default texture for the object;
one or more object keywords describing the object;
an indication of an account to receive remuneration when the object's default texture is replaced with the product placement texture; and
one or more object use restrictions.

3. The method of claim 2, wherein the one or more object use restrictions comprise at least one of:
restrictions on at least one particular advertiser;
restrictions on at least one particular advertiser under certain VU conditions;
restrictions under certain VU conditions; and
restrictions on certain VU locations.

4. The method of claim 1, wherein the receiving the one or more bids further comprises receiving:
an entity identifier;
one or more advertisement keywords;
a pay per placement amount; and
a texture universally unique identifier (UUID).

5. The method of claim 4, wherein the receiving the one or more bids further comprises receiving at least one of:
an additional payment per teleport amount and a teleport location UUID; and
one or more advertiser restrictions.

6. The method of claim 5, wherein the one or more advertiser restrictions comprise at least one of:
a minimum number avatars viewing the object;
a minimum number of avatars in a region of the object;
a minimum number of avatars viewing the object for a minimum period of time;
objects in particular locations in the VU;
objects under control of particular avatars;
objects under control of avatars having certain attributes; and
time of day in the VU.

7. The method of claim 1, further comprising storing the one or more received bids in a bid database.

8. The method of claim 7, further comprising:
retrieving all of the one or more received bids from the bid database having advertising keywords that match object keywords for consideration in the bid resolution;
detecting VU conditions; and
determining remaining bids by removing bids subject to at least one of object use restrictions and advertiser restrictions from consideration in the bid resolution based on the detecting.

9. The method of claim 8, wherein the performing the bid resolution comprises:
determining a total monetary amount of all remaining bids;
determining a percentage of the total monetary amount for each remaining bid; and
allocating the one or more dynamic product placement advertisements to objects in accordance with the determined percentages.

10. The method of claim 1, further comprising invoking the rendering when one or more objects having metadata indicating compatibility with the one or more product placement advertisements are detected within a region of the VU and viewable by one or more avatars.

11. The method of claim 1, further comprising:
determining a cost to one or more advertisers for placing the one or more dynamic product placement advertisements; and
determining a remuneration to one or more object owners for the one or more dynamic product placement advertisements.

12. The method of claim 1, wherein the receiving the one or more bids is at least one of:
ongoing;
according to a pre-determined schedule; and
for a predetermined time period.

13. The method of claim 1, wherein the receiving the one or more bids occurs at least one of:
within the VU; and
outside of the VU.

14. The method of claim 1, wherein a service provider at least one of creates, maintains, deploys and supports the computer infrastructure that performs the steps of claim 1.

15. The method of claim 1, wherein steps of claim 1 are provided by a service provider on a subscription, advertising, and/or fee basis.

16. A system, comprising:
an object definition tool configured to modify an object's metadata;
a bid placement tool configured to receive one or more bids for one or more dynamic product placement advertisements in a virtual universe (VU);
a placement resolution tool configured to determine an allocation of the one or more dynamic product placement advertisements based on the one or more received bids;
an invocation/placement tool configured to replace a default texture of the object with a product placement texture based on the allocation; and
a remuneration/billing tool configured to determine a cost to one or more advertisers and a remuneration for placing the one or more dynamic product placement advertisements.

17. The system of claim 16, further comprising a computer infrastructure operable to implement the object definition tool, the bid placement tool, the placement resolution tool, the invocation/placement tool and the remuneration/billing tool.

18. The system of claim 17, wherein a service provider at least one of creates, maintains, deploys and supports the computer infrastructure.

19. The system of claim 16, wherein the object definition tool is configured to modify the object's metadata to include at least one of:
an indication that the object is available for the one or more dynamic product placement advertisements;
a default texture for the object;
one or more object keywords describing the object;
an indication of an account to receive remuneration when the objects default texture is replaced with the product placement texture; and
one or more object use restrictions.

20. The system of claim 16, wherein the bid placement tool is configured to receive:
an entity identifier;
one or more advertisement keywords;
a pay per placement amount; and
a texture UUID.

21. The system of claim 16, wherein the placement resolution tool is configured to determine the allocation by:
retrieving all of the one or more received bids for consideration in a bid resolution from a bid database having advertising keywords that match object keywords;
detecting VU conditions;
determining remaining bids by removing bids subject to at least one of object use restrictions and advertiser restrictions from consideration in the bid resolution based on the detecting;
determining a total monetary amount of all remaining bids;
determining a percentage of the total monetary amount for each remaining bid; and
allocating the one or more dynamic product placement advertisements to the objects in accordance with the determined percentages.

22. A computer program product comprising a computer usable medium having readable program code embodied in the medium, wherein the computer program product includes at least one component to:
modify an object's metadata;
receive one or more bids for one or more dynamic product placement advertisements in a virtual universe (VU);
determine an allocation of the one or more dynamic product placement advertisements based on the one or more received bids; and
replace a default texture of the object with a product placement texture based on the allocation.

23. The computer program product of claim 22, wherein the at least one component is further configured to determine a cost to one or more advertisers and a remuneration to one or more object owners for placing the one or more dynamic product placement advertisements.

24. A method comprising:
providing a computer infrastructure operable to:
receive one or more bids for one or more dynamic product placement advertisements in a virtual universe (VU);
perform a bid resolution for the one or more received bids; and
render an object in the VU as a product placement advertisement by replacing a default texture of the object with a product placement texture based on the bid resolution.
